(19) United States
(12) Patent Application Publication
(10) Pub. No.: US 2008/0001488 A1
(43) Pub. Date: Jan. 3, 2008

(54) Axial Flux Induction Electric Machine

(75) Inventors: Juha Pyrhonen, Lappeenranta (FI); Ari Piispanen, Lappeenranta (FI)

Correspondence Address: BROOKS KUSHMAN P.C., 1000 TOWN CENTER, TWENTY-SECOND FLOOR, SOUTHFIELD, MI, 48075, US

(73) Assignee: AXCO-MOTORS OY, Lappeenranta (FI)

(21) Appl. No.: 11/574,166

(22) PCT Filed: Aug. 25, 2005
(86) PCT No.: PCT/FI05/00367

§ 371 Date: Mar. 17, 2007

(30) Foreign Application Priority Data
Aug. 25, 2004 (FI) 20041113

(51) Int. Cl. H02K 17/16; H02K 15/02; H02K 9/06

(52) U.S. Cl. 310/60 R; 310/166; 310/182; 310/262; 310/268

(57) ABSTRACT

The invention relates to an axial flux induction electrical machine comprising a frame, a shaft (1) bearing-mounted to the frame, a disc-like rotor (2) supported to the shaft, a stator (4) comprising a stator winding (3) and supported by the frame on the first side of the rotor in axial direction. The disc-like rotor (2) comprises a non-ferromagnetic rotor frame (8) fabricated of a material with high electrical conductivity and comprising a uniform inner periphery (9) and an outer periphery (10) and conductor bars (11) fabricated of the same material and galvanically connecting the peripheries (11), the conductor bars together with the inner and outer peripheries forming in addition to the rotor frame also the cage winding of the rotor. In addition, between the inner periphery and the outer periphery there is a plurality of ferromagnetic pieces (12) extending through the frame plate and being spaced apart from each other at an appropriate distance so that the radial conductor bars are appropriately located between the pieces. According to the invention, the disc-like rotor frame (8) comprises at least one circular plate machined of work-hardened metal sheet.

### FIELD OF THE INVENTION

The invention relates to an axial flux induction electrical machine as defined in the preamble of claim 1. The invention is chiefly developed to function as a motor, but also different generator embodiments may come into question.

### BACKGROUND OF THE INVENTION

An axial flux machine as such is not by nature very well applicable as a high-speed induction machine, because the characteristics of an induction machine are usually the best when there are only few poles (two, or four at the maximum) in the machine. However, a two-pole solution is often unsuitable for an axial flux machine, because the end-winding arrangement of the stator winding is not often a functional solution in a two-pole machine. Therefore, also a high-speed axial flux machine has usually to be designed at least as a four-pole configuration. In that case both the magnetic flux in the stator yoke and the current of the machine in the windings have to flow a quarter of the inner and outer peripheries of the machine tangentially without producing torque.

An axial flux induction machine is nevertheless an interesting alternative to be integrated with various actuators, in which case the price of the configuration becomes lower than before.

There are known to be several types of axial flux machines. Their advantage is that the stator can be fabricated of strip by winding, the loss of material being thus very small. Another advantage of an axial flux machine is that the machine becomes very short. Permanent magnet axial flux machines in particular are found in practical embodiments.

Well-known technology in the field of the invention is presented in U.S. Pat. No. 3,296,475. The aforementioned patent describes an axial flux machine with a disc-like rotor fabricated by casting. The structure is simple and easy to construct, but its major disadvantage is its low durability already at moderately high rotation speeds. Therefore the structure is suitable only for low rotation speeds, usually below 3000 rpm.

### OBJECT OF THE INVENTION

It is an object of the present invention to eliminate the aforementioned drawbacks. The object of the invention in particular is to introduce a novel axial flux induction machine, the configuration of which is simple and compact and which endures also high rotation speeds, above 10,000 rpm, and even above 30,000 rpm, and which can be conveniently integrated with various power tools such as, for instance, pumps, blowers, and compressors.

### SUMMARY OF THE INVENTION

The axial flux induction electrical machine of the invention is characterized in what will be presented in claim 1.

An axial flux induction machine of the invention comprises a frame, a shaft bearing-mounted to the frame, a disc-like rotor supported by the shaft, and a stator comprising a stator winding and supported by the frame on the first side of the rotor in axial direction. The disc-like rotor comprises a non-ferromagnetic rotor frame fabricated of a material with high electrical conductivity, the rotor frame comprising uniform inner and outer peripheries and conductor bars fabricated of the same material, the conductor bars galvanically connecting the inner and outer peripheries, and the conductor bars together with the inner and outer peripheries forming in addition to the rotor frame also the cage winding of the rotor. Between the inner and outer peripheries of the rotor there is a plurality of ferromagnetic pieces projecting through the frame plate and being spaced apart from each other at an appropriate distance so that the radial conductor bars of the rotor are located appropriately between the pieces. In accordance with the invention the disc-like rotor frame comprises at least one circular plate machined of work-hardened metal sheet.

The rotor frame is preferably machined of rolled or otherwise work-hardened aluminum alloy sheet, the electrical conductivity of which is good, being for instance as near as possible to that of pure aluminum, 35 MS/m, and usually varying between 15-28 MS/m, and the relative permeability of which being ≈1. Appropriate aluminum alloys are both durable and have a good electrical conductivity. Pure aluminum conducts electricity better than aluminum alloys, but it is mechanically brittle, and therefore its application in high-speed machines cannot be justified.

In common induction motors instead, as pure aluminum as possible is often used in casting the cage windings of the rotor of the machine. A surprising feature of the invention is the application of appropriately composed aluminum alloy both in the electrically conductive structure and in the actual rotor frame structure. In the invention, application of a suitable copper alloy may similarly come into question. In this rotor steel is used as a path for the magnetic flux, whereas in the commonly known technique steel parts comprise the load-bearing structures of the rotor. When using strong aluminum or copper in the entire rotor, that is, both in the rotor frame and in the short-circuit rings, a firm structure is achieved that endures well also the centrifugal forces caused by the ferromagnetic parts in the rotor.

The material of a work-hardened frame plate can also be defined as being preferably fabricated of strong, non-ferromagnetic material, with a relative permeability ≈1 and with as high conductivity as possible.

The rotor frame preferably comprises two or a plurality of work-hardened plates joined together. The case-specific number of plates may also be higher, for instance even between 10-20 plates. In order to increase the durability of the rotor, carbon fibre plates can be used on the rotor surface or preferably between the plates of the rotor. Further, in the carbon fibre plates the fibres are preferably oriented to receive the centrifugal forces acting in the direction of the rotor radius. Further, as is well known, the carbon fibre contracts when it warms up, tightening thus the rotor structure in radial direction even more during operation.

In an embodiment of the invention, on the surface of the rotor frame and/or between the rotor plates, there are blades or other corresponding motor parts in order to produce the cooling air flow. For this purpose, there may be axial holes in the rotor, through which the air can flow to the blades positioned between the rotor plates or to other corresponding ventilating ducts. With the created air currents it is possible to efficiently cool the stator, the rotor, and other parts of the motor.

It is also possible that blower blades are integrated into the rotor surface, in which case the blower and the motor rotating it together have as few rotating surfaces as possible. Hence the surface frictions can be minimized, which in high rotation speeds significantly improves the efficiency of the entire configuration.

In a preferred embodiment, the ferromagnetic pieces of the rotor are fabricated of common structural steel, for instance Fe52. The saturation flux density of this steel grade is high, and the steel grade is therefore suitable for carrying the magnetic flux through the rotor. It is obvious to a person skilled in the art that any material with a high permeability and high saturation flux density may come into question for carrying this magnetic flux through the rotor. The material may also be some appropriate composite material with the above described electromagnetic characteristics. It is preferable for the ferromagnetic parts to have a low electrical conductivity. Usually, however, as the electrical conductivity becomes lower in steels, also the saturation flux density becomes lower, and therefore a satisfactory compromise has to be found. In order to reduce iron losses, solid steel parts can also be replaced with laminate materials. In that case the paths for the magnetic flux passing through the rotor are constructed by laminating from small pieces of electrical sheet.

The ferromagnetic pieces are preferably extending in the direction of the radius of the rotor and taking the form of a truncated narrow sector.

In an embodiment of the invention the element for conducting the magnetic flux is a laminated ring or disc fabricated of ferromagnetic material. Such an annular or disc-like element is preferably supported to the machine frame, in other words, it is stationary and at an appropriately small air gap distance from the rotating rotor. If there are no windings in the element in question, it comprises in practice the magnetic back part of the rotor, through which the magnetic flux passes over a pole pitch and then returns through the rotor, back to the actual stator.

An advantage of the element is that when using the element the machine produces very little axial force, because nearly the same magnetic flux flows over both air gaps of the machine.

It is also possible that the annular or disc-like element for the conduction of the magnetic flux is supported to the rotor, that is, it is a part of the rotating rotor. Instead of a laminated element, a solid steel rotor yoke, the function of which again is to carry the flux in the rotor over the pole pitch so that the flux can return back to the stator, can, if desired, be attached on the back surface of the above described rotor. In this case a remarkably high axial force is created, yet it can be accepted in certain embodiments. The construction is of special interest due to the fact that in this rotor construction for instance a blower blade or pump blade can be fixed directly to the rotating rotor yoke, thus producing a fully integrated machine solution. From electromagnetic point of view, a solid rotor yoke is a disadvantageous solution, however, if the rotor winding is fabricated of aluminum the slip frequency of the rotor is kept very low, the solid rotor yoke being thus of only marginal disadvantage.

In an embodiment of the invention, by using two fixed stators, one at both sides of the rotor, the magnetic flux of the electrical machine is made to flow over both air gaps, in which case only a marginal amount of axial magnetic net attractive force is produced in the machine. This remarkably simplifies and lightens the bearing required in the machine. A precondition for this kind of force balance is however that the magnetic flux is not allowed to flow tangentially in the rotor disc. In the invention this precondition is met by an anisotropic rotor construction. In practice the magnetic flux flows very directly through the rotor, yet being tangentially almost non-ferromagnetic. In the rotor there are only ferromagnetic pieces guiding the magnetic flux in axial direction through the rotor from one stator to another.

The construction of the invention has significant advantages when compared with the known technology. The machine configuration as a whole becomes very short, it is easy to integrate with power tools, and it is easy to manufacture. The rotor of the invention is very durable when compared with traditional rotor constructions, which enables high rotation speeds.

### BRIEF DESCRIPTION OF THE DRAWINGS

The invention will now be described in greater detail by means of examples with reference to the attached drawings, in which

FIG. 1 is a schematic representation of a side view of the first embodiment of the electrical machine of the invention and its rotor from another direction,

FIG. 2 is a view similar to FIG. 1, showing the second embodiment of the invention,

FIG. 3 shows the paths of the current and the magnetic flux of the machine of FIG. 1,

FIG. 4 shows a rotor cage winding of the invention,

FIG. 5 shows the first embodiment of the ferromagnetic piece to be attached to the cage winding of FIG. 4,

FIG. 6 shows the second embodiment of the ferromagnetic piece to be attached to the cage winding of FIG. 4,

FIG. 7 is a view similar to FIG. 1, showing the third embodiment of the invention and

FIG. 8 shows a side view of a rotor of the invention.

### DETAILED DESCRIPTION OF THE INVENTION

FIG. 1 illustrates an electrical machine of the invention in which there is a shaft 1 rotating with respect to the machine frame, and a disc-like rotor 2 supported to the shaft, the rotor also being viewed from the side. In the direction of the shaft 1 on the first side of the rotor 2 there is a stator 4 supported to the machine frame and comprising a stator winding 3. There is a small air gap 14 between the rotor 2 and the stator 4, and after the corresponding air gap 15 on the other side of the rotor there is an element to conduct the magnetic flux, the element being in this embodiment the rotor yoke 5 that is fixed with respect to the frame. The rotor yoke 5 may be fabricated of appropriate composite material or it may be spiral laminated from electrical sheet. The rotor frame plate 8 is machined of work-hardened, rolled sheet of suitable aluminum alloy or copper alloy.

In the second embodiment of FIG. 2 the rotor 2 and the stator 4 are similar to the embodiment of FIG. 1. The element 6 to conduct the magnetic flux instead is a construction corresponding to the stator 4, comprising the stator winding 13.

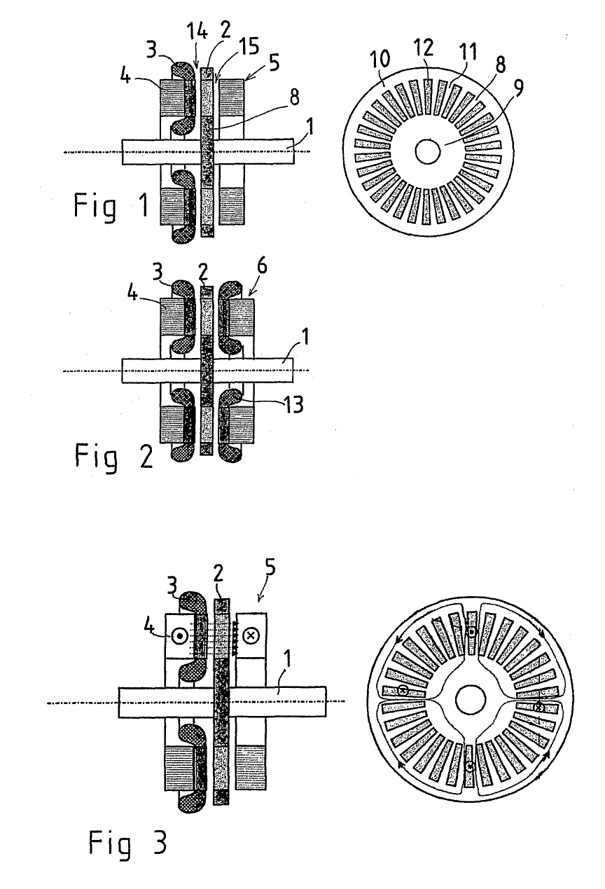

The paths of the magnetic flux and of the current in the machine construction of the electrical machine of FIG. 1 are indicated in FIG. 3.

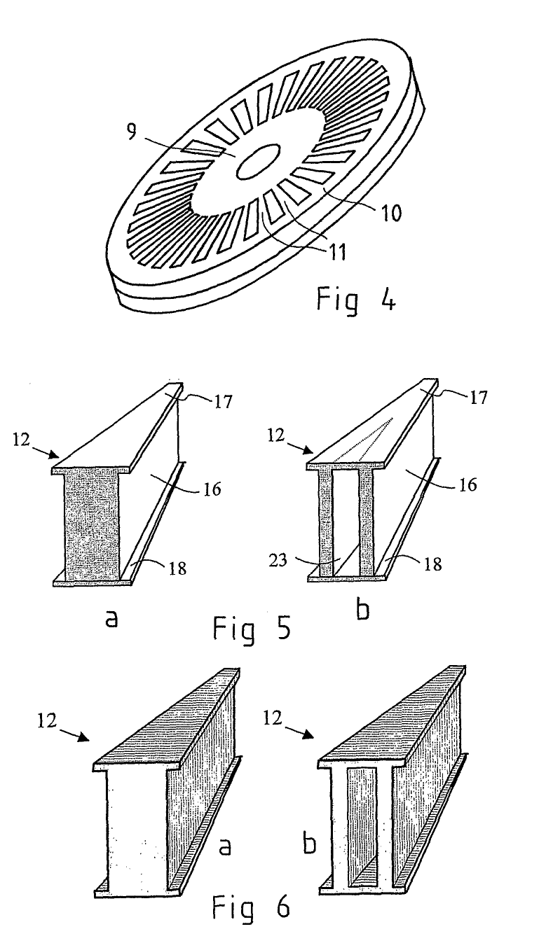

FIG. 4 shows a further detailed view of the rotor embodiment of the invention comprising two plates joined together. The plates have been machined for instance by precision stamping from work-hardened aluminum alloy sheet. The frame plate 8 formed of the cage winding comprises a uniform inner periphery 9 and a uniform outer periphery 10 and conductor bars 11 of the same material, the conductor bars galvanically connecting the peripheries. The conductor bars are bars of equal size extending in the direction of the rotor radius, located at even distances between the inner and outer peripheries. Between the peripheries and conductor bars, a plurality of elongated apertures is thus formed at even distances in the direction of the rotor radius, ferromagnetic pieces 12 of the corresponding shape with the apertures being inserted in the apertures and creating paths for the magnetic flux in axial direction through the otherwise non-ferromagnetic frame plate 8 of the rotor 2.

FIG. 5a shows an alternative structure of the ferromagnetic piece 12. The piece is of the similar shape as the rotor apertures, tapering inwards in the direction of the rotor radius. The piece comprises a solid web 16 to be inserted in the rotor aperture, the other end surface of the web comprising a solid support flange 17 fixed with respect to the web and being of larger width than the web. The web can thus be fitted in the rotor aperture so that the web fills the aperture completely, the support flange simultaneously preventing the shifting of the web through the aperture. A fastening flange 18 corresponding with the support flange is fixed to the web on the other side of the aperture, the fastening flange fastening the ferromagnetic piece 12 to its place. As such, the fastening of the fastening flange 18 to the web 16 can be carried out by any suitable method, as for instance by welding, screwing and/or gluing.

FIG. 6a illustrates the second alternative structure of the ferromagnetic piece 12. In this embodiment, thin H-shaped steel laminates have been used, the laminates being stacked one after the other into the rotor aperture. Most of the laminates can be turned and set into place in lock-up position, and only the last few laminates have to be of T-shape in order to set them into place.

FIGS. 5b and 6b also show alternative constructions for the ferromagnetic pieces 12. Because the relative proportion of iron increases in the rotor towards the outer periphery, and thus the flux density decreases significantly towards the outer periphery, the centrifugal force of the iron part causes also unnecessary stress to the aluminum holding the rotor together. Therefore the iron piece can be lightened without the electromagnetic characteristics of the motor suffering. Hence the FIGS. 5b and 6b illustrate sector-shaped inward-tapering lightening apertures 23 or cavities in the webs 16 so that on both sides of the cavity along its full length the web plates are of uniform thickness.

An alternative method would be to construct the web in uniform thickness, but in that case the support flange 17 and the fastening flange 18 would become notably wider than the web on the outer periphery, in which case both the mechanical and magnetic characteristics would suffer.

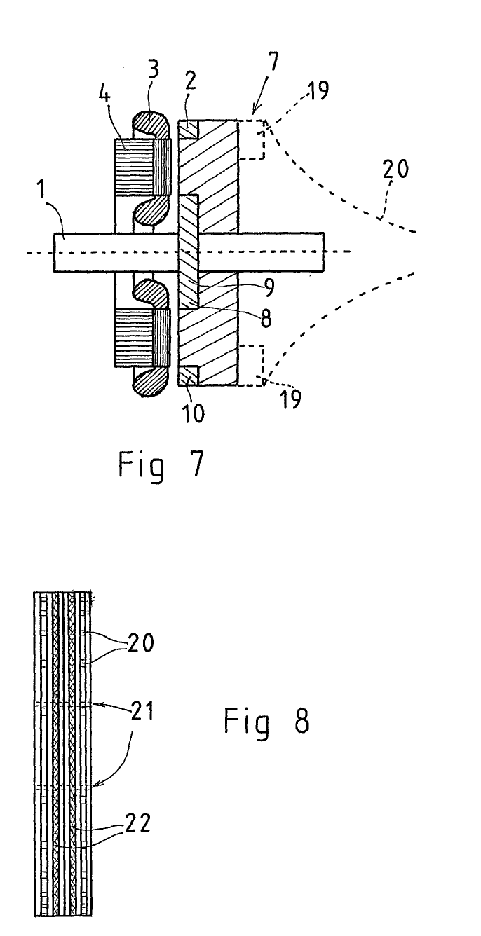

FIG. 7 further shows, in a way corresponding to that of FIGS. 1 and 2, the third embodiment of the invention in which a solid ferromagnetic steel plate with teeth fitted in the apertures of the aluminum rotor is fixed to the surface of the rotor 2 on the opposite side of the stator 4 to function as an element 7 to conduct the magnetic flux. Thus the ferromagnetic teeth projecting through the aluminum cage of the rotor and the uniform ferromagnetic plate located on the backside of the rotor viewed from the stator together form a path for the magnetic flux.

The dashed lines in FIG. 7 further indicate an embodiment of the invention in which blades 19 have been arranged on the outer surface of the steel plate 7 close to its outer periphery. These blades can be machined to the steel plate or they may be separate structures attached with an appropriate method to the steel plate 7. An efficient blower in which the surface friction caused by rotating surfaces has been minimized, is achieved easily and simply by integrating an appropriate housing 20 with the construction. In that case the integrated solution becomes notably more inexpensive than the traditional radial flux configurations.

As it is shown in FIG. 8, it is also possible that in the laminated frame plate 8 in which there are several layers, one or several plates in the middle are removed and replaced with appropriate spacers, as for instance with radially extending blades 20. Radially extending ducts are thus created in the frame plate, the ducts realizing the integrated blower that efficiently cools the structures. In that case there are ducts 21 preferably extending through the rotor in axial direction close to the shaft, the ducts functioning as inlet openings of air.

FIG. 8 further illustrates the second embodiment of the invention in which two carbon fibre plates 22 are located between the metal plates. These plates increase the radial rigidity of the rotor supporting the surrounding metal plates particularly when the carbon fibres in the plate are appropriately oriented mainly in radial direction. Therefore the rotor endures higher rotation speeds. Thus in the rotor structure of the invention laminated of a plurality of metal plates, the metal plates function as a load-bearing structure holding the rotor together in radial direction while the ferromagnetic pieces of the FIGS. 5 and 6 arranged to extend through the apertures of the plates hold the plates together in axial direction.

The invention is not restricted to the embodiments described above as examples, but many variations are possible within the scope of the inventive idea defined by the claims.

1. An axial flux induction electrical machine comprising a frame, a shaft bearing-mounted to the frame, a disc-like rotor supported to the shaft, a stator comprising a stator winding and supported by the frame on the first side of the rotor in axial direction, in which case the disc-like rotor comprises a non-ferromagnetic rotor frame fabricated of a material with high electrical conductivity and comprising a uniform inner periphery and an outer periphery and conductor bars fabricated of the same material and galvanically connecting the peripheries; the conductor bars together with the inner and outer peripheries forming in addition to the rotor frame also the cage winding of the rotor; between the inner periphery and the outer periphery there is a plurality of ferromagnetic pieces extending through the frame plate and being spaced apart from each other at an appropriate distance so that the radial conductor bars of the rotor are appropriately located between the pieces, characterized in that the disc-like rotor frame comprises at least one circular plate machined of work-hardened metal sheet.

2. An axial flux induction electrical machine as defined in claim 1, characterized in that the rotor frame comprises two or a plurality of plates joined together.

3. An axial flux induction electrical machine as defined in claim 1, characterized in that the relative permeability of the material of the rotor frame plate is approximately 1.

4. An axial flux induction electrical machine as defined in claim 1, characterized in that the rotor frame is composed of aluminum alloy or copper alloy.

5. An axial flux induction electrical machine as defined in claim 1, characterized in that there are blades or corresponding motor parts on the surface of the rotor frame and/or between its plates to produce the cooling air flow.

6. An axial flux induction electrical machine as defined in claim 1, characterized in that between the plates of the rotor frame and/or on the surface there is at least one carbon fibre plate in which the fibres are oriented to carry centrifugal forces.

7. An axial flux induction electrical machine as defined in claim 1, characterized in that the ferromagnetic pieces are of structural steel and/or of laminated plate structure.

8. An axial flux induction electrical machine as defined in claim 1, characterized in that the ferromagnetic pieces are extending in the direction of the radius of the rotor and essentially taking the form of truncated narrow sector.

9. An axial flux induction electrical machine as defined in claim 8, characterized in that the web of the ferromagnetic piece comprises a lightening aperture, such as a middle cavity in radial direction so that the flux density in the web remains essentially constant in the area of the lightening aperture.

10. An axial flux induction electrical machine as defined in claim 1, characterized in that the electrical machine comprises on the other side of the rotor in axial direction an element to conduct magnetic flux, the element being a ring or a disc fabricated of ferromagnetic material.

11. An axial flux induction electrical machine as defined in claim 10, characterized in that the annular or disc-like element to conduct the magnetic flux is supported to the frame.

12. An axial flux induction electrical machine as defined in claim 10, characterized in that the annular or disc-like element to conduct the magnetic flux is supported to the rotor.

13. An axial flux induction electrical machine as defined in claim 2, characterized in that the rotor frame is composed of aluminum alloy or copper alloy.

14. An axial flux induction electrical machine as defined in claim 2, characterized in that there are blades or corresponding motor parts on the surface of the rotor frame and/or between its plates to produce the cooling air flow.

15. An axial flux induction electrical machine as defined in claim 2, characterized in that between the plates of the rotor frame and/or on the surface there is at least one carbon fibre plate in which the fibres are oriented to carry centrifugal forces.

16. An axial flux induction electrical machine as defined in claim 2, characterized in that the ferromagnetic pieces are of structural steel and/or of laminated plate structure.

17. An axial flux induction electrical machine as defined in claim 1, characterized in that the ferromagnetic pieces are extending in the direction of the radius of the rotor and essentially taking the form of truncated narrow sector.

18. An axial flux induction electrical machine as defined in claim 1, characterized in that the electrical machine comprises on the other side of the rotor in axial direction an element to conduct magnetic flux, the element being a ring or a disc fabricated of ferromagnetic material.

19. An axial flux induction electrical machine as defined in claim 3, characterized in that the rotor frame is composed of aluminum alloy or copper alloy.

20. An axial flux induction electrical machine as defined in claim 3, characterized in that there are blades or corresponding motor parts on the surface of the rotor frame and/or between its plates to produce the cooling air flow.
